(19) United States
(12) Patent Application Publication
(10) Pub. No.: US 2008/0080400 A1
(43) Pub. Date: Apr. 3, 2008

(54) Switching fabric device discovery

(76) Inventors: Randeep Kapoor, Gilbert, AZ (US); Mo Rooholamini, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/541,215

(22) Filed: Sep. 29, 2006

(51) Int. Cl. H04L 12/28

(52) U.S. Cl. 370/255; 370/389

(57) ABSTRACT

A method includes a fabric manager implementing a scheme to discover one or more devices coupled to the switch fabric. The scheme to include the fabric manager locating a device coupled to the fabric manager via a path routed through the switch fabric. The fabric manager to also collect information via the path to determine one or more memory locations at the device that stores information associated with a plurality of capabilities for the device to operate on the switch fabric. The fabric manager to read the one or more memory locations at the device based on the determination. This reading is to occur such that the information associated with the plurality of capabilities is read in a parallel manner via the path. A table is maintained by the fabric manager for the device, the table to include the information associated with the plurality of capabilities that was read from the one or more memory locations. The fabric manager is to use the table to configure the device for operating on the switch fabric. The fabric manager is to also enter the device in a fabric map for the switch fabric.

### RELATED APPLICATION

This application is related to commonly assigned U.S. application Ser. No. 11/173,784, filed by Victoria V. Genovker, Ward McQueen, Mo Rooholamini and Mark Sullivan on Mar. 31, 2004 and entitled “Advanced Switching Fabric Discovery Protocol.”

### BACKGROUND

In networking environments such as those used in telecommunication and/or data centers, a switch fabric is utilized to rapidly move data. Typically a switch fabric includes one or more nodes or devices (e.g., endpoints, switches, modules, blades, boards, etc.) interconnected via point-to-point communication links. The switch fabric may operate in compliance with industry standards and/or proprietary specifications. One example of an industry standard is the Advanced Switching Interconnect Core Architecture Specification, Rev. 1.1, published November 2004, or later version of the specification (“the ASI specification”). The ASI specification is available through the ASI special interest group (ASI SIG).

Typically a switch fabric in a telecommunication and/or data center environment includes a switch fabric management architecture to maintain a highly available communication medium and to facilitate the movement of data through the switch fabric. As part of a typical switch fabric management architecture, one or more devices may host a fabric manager that manages/controls at least a portion of each device's switch fabric configuration as well as the communication links that interconnect the devices coupled within the switch fabric (e.g., via spanning tree or fabric ownership). These host devices may also be recognized as the fabric owners and are well known by the other devices of the switch fabric. A fabric managers is typically hosted by a device that is an endpoint (e.g., a device coupled to the edge of the switch fabric) with adequate resources to support the functionalities carried out by the fabric manager, e.g., processing power, memory, communication bandwidth, etc.

An important function carried out by a fabric manager includes the discovery of devices interconnected within a switch fabric. A switch fabric that operates in compliance with the ASI specification may complete a multiphase process or scheme to locate, identify and configure these devices for operating on the switch fabric. Typically, the manner in which each phase of the process is completed is substantially user-defined as long as each device is ultimately configured to meet the minimal ASI specification requirements.

### BRIEF DESCRIPTION OF THE DRAWINGS

FIG. 1 is an illustration of an example switch fabric;

FIG. 2 is a block diagram example architecture for an endpoint hosting a fabric manager;

FIG. 3 is an illustration of portions of a memory at a device coupled within the switch fabric;

FIG. 4 is a diagram of an example scheme to discover a device coupled to the switch fabric;

FIGS. 5A-C are example message formats to discover and configure a device coupled to the switch fabric; and

FIG. 6 is an example state diagram depicting the fabric manager implementing the scheme to discover devices coupled to the switch fabric.

### DETAILED DESCRIPTION

As mentioned in the background, the manner in which each phase of device discovery is completed is substantially user-defined. Typically, switch fabric interconnections or topologies are complex and may frequently change due to device removals/additions (e.g., hot swapping), communication link failures, device failovers, etc. Therefore, implementing a device discovery scheme that is slow or inefficient may be problematic to meeting stringent reliability needs of telecommunication and/or data centers that commonly employ switch fabrics to rapidly move data.

In one example, a fabric manager implements a scheme to discover one or more devices coupled to the switch fabric. The scheme to include the fabric manager locating a device coupled to the fabric manager via a path routed through the switch fabric. The fabric manager to also collect information via the path to determine one or more memory locations at the device that stores information associated with a plurality of capabilities for the device to operate on the switch fabric. The fabric manager to read the one or more memory locations at the device based on the determination. This reading is to occur such that the information associated with the plurality of capabilities is read in a parallel manner via the path. A table is maintained by the fabric manager for the device, the table to include the information associated with the plurality of capabilities that was read from the one or more memory locations. The fabric manager is to use the table to configure the device for operating on the switch fabric. The fabric manager is to also enter the device in a fabric map for the switch fabric.

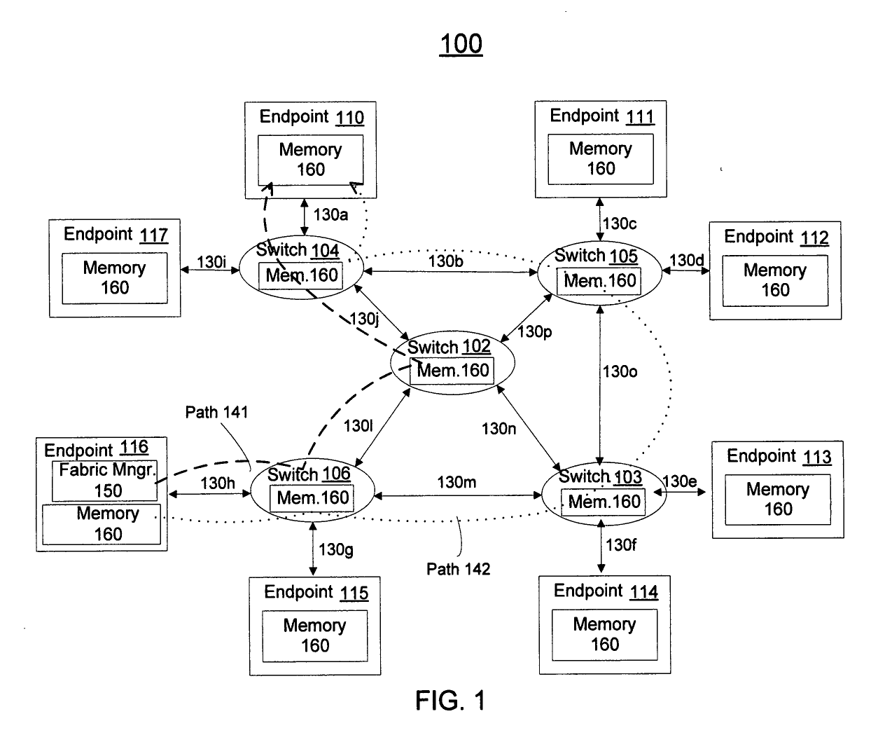

FIG. 1 is an illustration of an example switch fabric 100. As shown in FIG. 1, switch fabric 100 includes various devices graphically depicted as switches 102-106 and endpoints 110-117. In one example, each of these devices is coupled to switch fabric 100 with endpoints 110-117 being coupled on the edge or ends of switch fabric 100 and switches 102-106 being coupled within switch fabric 100.

In one example, switch fabric 100 is operated in compliance with the ASI specification, although this disclosure is not limited to only switch fabrics that operate in compliance with the ASI specification. In FIG. 1, endpoint 116 is depicted as hosting fabric manager 150. Endpoint 116, for example, includes the resources needed to host a fabric manager for switch fabric 100, e.g., adequate processing power, memory, communication bandwidth, etc. As a result, endpoint 116 may have been selected/elected as a fabric owner or manager for switch fabric 100. This selection/election, for example, is according to the criteria described in the ASI specification.

In one example, as depicted in FIG. 1, switch fabric 100 includes communication links 130a-p. These communication links include point-to-point communication links that interconnect or couple in communication the devices (e.g., endpoints 110-117, switches 102-106) of switch fabric 100. These communication links may include wired mediums, wireless mediums or combinations thereof to propagate communication signals between the devices.

As depicted in FIG. 1, for example, each device in switch fabric 100 includes memory 160. Memory 160, for example, includes one or more memory locations (e.g., associated with physical memory addresses, apertures, registers or combinations thereof) to store information associated with a plurality of capabilities for a given device to operate in or on switch fabric 100. These capabilities may include, but are not limited to, unique identification, spanning tree tables, communication protocol interfaces supported, multicast routing (if a switch), communication channel bandwidth and monitoring events and/or reporting events. As described more below, these memory locations may be identified by a fabric manager (e.g., fabric manager 150) and read in a parallel manner via a path routed through the switch fabric. That read information, for example, is maintained by the fabric manager and possibly used to initialize or configure a given capability for the given device to operate on switch fabric 100.

In one implementation, following the selection/election of endpoint node 116 as the host for fabric manager 150, fabric manager 150 implements a device discovery scheme. This discovery scheme, for example, includes locating one or more devices coupled to or within switch fabric 100, e.g., endpoints 110-115 and 117 and switches 102-106. In one example, fabric manager 150 locates endpoint 110 via one or more paths routed through the switch fabric. FIG. 1 depicts two example paths between fabric manager 150 hosted by endpoint 116 and endpoint 110 based on switch fabric 100's topology. Path 141, for example, is depicted as a dotted-line that passes through switches 106, 103, 105 and 104, respectively and through communication links 130h, 130m, 130o, 130b and 130a, respectively. Path 142, for example, is depicted as a dashed-line that passes through switch 106, 102 and 104, respectively and through communication links 130h, 130i, 130j and 130a, respectively.

In this implementation, fabric manager 150 may collect information via path 141 and/or 142 to determine the memory location(s) for information associated with endpoint 110's capabilities. This information, for example, is collected via read request and corresponding read completion data packets (described more below) that are routed via path 141 and/or path 142. Based on the information collected, for example, fabric manager 150 reads the memory location(s) in a parallel manner to obtain the capability information.

In one example, this parallel manner may include fabric manager 150 sending one or more read request data packets to endpoint 110 via path 141 and/or 142 to obtain information for a plurality of capabilities. These read request data packets, for example, may each include block read requests that enable fabric manager 150 to read a multitude of memory locations (e.g., blocks of memory) in memory 160 at endpoint 110. Or a plurality of read request data packets in composite may allow fabric manager 150 to read a multitude of memory locations should endpoint 110 not support a block read functionality or should information associated with the plurality of capabilities be located in blocks of memory that are non-contiguous (e.g., located in different apertures) and/or too large to fit within a given block of memory.

In one example, fabric manager 150 maintains a table (e.g., at endpoint 116's memory 160) for endpoint 110 that includes the information associated with the plurality of capabilities that was read from endpoint 110's memory 160. This information maintained in the table for endpoint 110, for example, is used to configure endpoint 110 for operating on switch fabric 100. Endpoint 110 may also be added by fabric manager 150 to a switch fabric 100 map, e.g., maintained at a memory resident on endpoint 116 and/or responsive to fabric manager 150. The switch fabric 100 map includes each device discovered by fabric manager 150, for example, as described above for discovering endpoint 110. The switch fabric 100 map may also include an indication of at least a portion of the capabilities read from memory location(s) at each device and maintained in a respective capability table for each discovered device. In one example, the switch fabric 100 map is used by fabric manager 150 to facilitate its management/control of switch fabric 100.

In one implementation, switch fabric 100 operates in compliance with the ASI specification. In this implementation, a unique identification for endpoint 110 may have not been initialized at endpoint 110 prior to fabric manager 150 collecting, reading and maintaining a table for endpoint 110 via a path that is a non-primary path. According to the ASI specification a primary path provides privileged access for a fabric manager to configure or initialize a capability of a device. Initialization of a unique identification, according to the ASI specification is part of configuring the device.

In one example, following selection/election of endpoint 116 to host fabric manager 150, fabric manager 150 gains ownership of a given spanning tree (ST) path coupled between fabric manager 150 and each device in switch fabric 100, e.g., endpoint 110. That ST path is known, for example, by each device and fabric manager 150 and is considered as the primary path. For example, the ST path may be path 141 and fabric manager 150 can forward management/control instructions to endpoint 110 via path 141. Thus, ownership of path 141 grants fabric manager 150 privileged access to endpoint 110 to configure endpoint 110 to operate on switch fabric 100, e.g., write information into endpoint 10's configuration memory locations that are port of its memory 160. Thus if endpoint 110 receives a configuration request (e.g., initialization of a unique identification) it ignores the request if the request was not routed via path 141. Since fabric manager 150 is the ST path owner of path 141 and in this example path 142 is not an ST path owned by fabric manager 150, path 142 is a non-primary path.

In this ASI compliant implementation, fabric manager 150 may maintain a device capability table for information obtained via path 141 and maintain an other device capability table for information obtained via path 142. This may result in endpoint 110 having two entries in the switch fabric 100 map. Thus, in one example, fabric manager 150 consolidates the information into a single capability table for endpoint 110 and removes the redundant/duplicate entry associated with the non-primary path from the switch fabric 100 map.

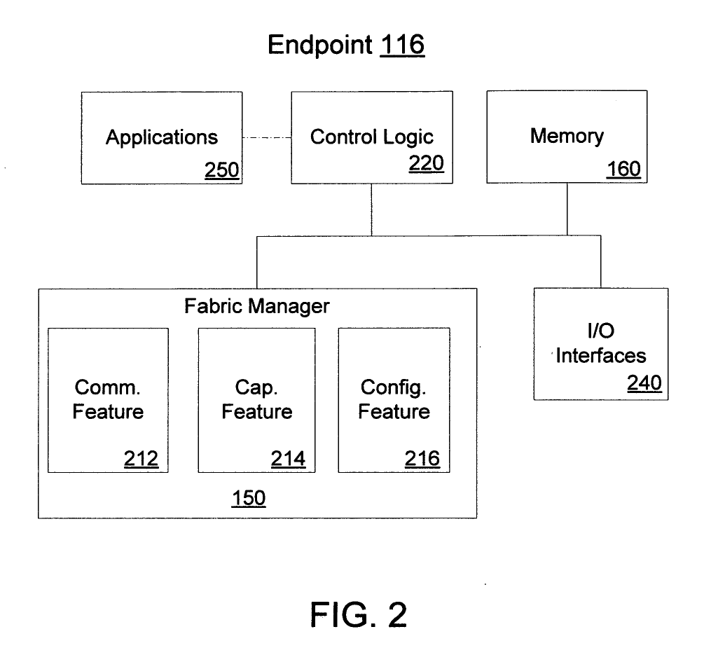

FIG. 2 is a block diagram example architecture for endpoint 116 that hosts fabric manager 150. In FIG. 2, endpoint nodes 116's architecture is depicted as including fabric manager 150, control logic 220, memory 160, input/output (I/O) interfaces 240, and optionally one or more applications 250, each coupled as depicted.

In one implementation, control logic 220 is a resource resident on endpoint 116 and controls the overall operation of endpoint 116 and may represent any of a wide variety of logic device(s) or executable content an endpoint node allocates to host fabric manager 150. Control logic 220 may be a microprocessor, network processor, microcontroller, field programmable gate array (FPGA), application specific integrated chip (ASIC), or any combination thereof

In FIG. 2, fabric manager 150 includes communicate feature 212, capability feature 214 and configuration feature 216. In one implementation, the features of fabric manager 150, responsive to control logic 220, implement a scheme to discover one or more devices coupled to switch fabric 100 to include locating the device, collecting and reading information associated with the device's capabilities, maintaining a table for the device and entering the device in a switch fabric 100 map.

According to one example, as mentioned above for FIG. 1, memory 160 may have portions allocated to include memory locations (e.g., apertures) to store information associated with endpoint 116's capabilities. Memory 160 may also include other portions (e.g., random access memory (RAM)) to store encoding/decoding information to facilitate or enable the generation of packet-based messages that are received or transmitted when features of fabric manager 150 implement a scheme to discover devices coupled to switch fabric 100. Fabric manager 150, for example, at least temporarily stores or maintains device capability tables for each device discovered in these other portions of memory 160. A fabric map may also be stored or maintained in these other portions of memory 160.

I/O interfaces 240 provide a communications interface via a communication medium or link between endpoint 116 and other devices coupled to or remote to switch fabric 100. As a result, I/O interfaces 240 enable control logic 220 to receive a series of instructions from application software running on endpoint 116 or external to endpoint node 116. The series of instructions may cause control logic 220 to activate fabric manager 150 to implement a scheme to discover one or more devices coupled to switch fabric 100.

In one example, endpoint 116 includes one or more applications 250 to provide internal instructions to control logic 220. Such applications 250 may be activated to generate a user interface, e.g., a graphical user interface (GUI), to enable administrative features, and the like. For example, a GUI provides a user access to memory 160 to modify or update information to facilitate fabric manager 150's discovery of devices coupled to switch fabric 100.

In an other example, applications 250 include one or more application interfaces to enable external applications to provide instructions to control logic 220. One such external application could be a GUI as described above.

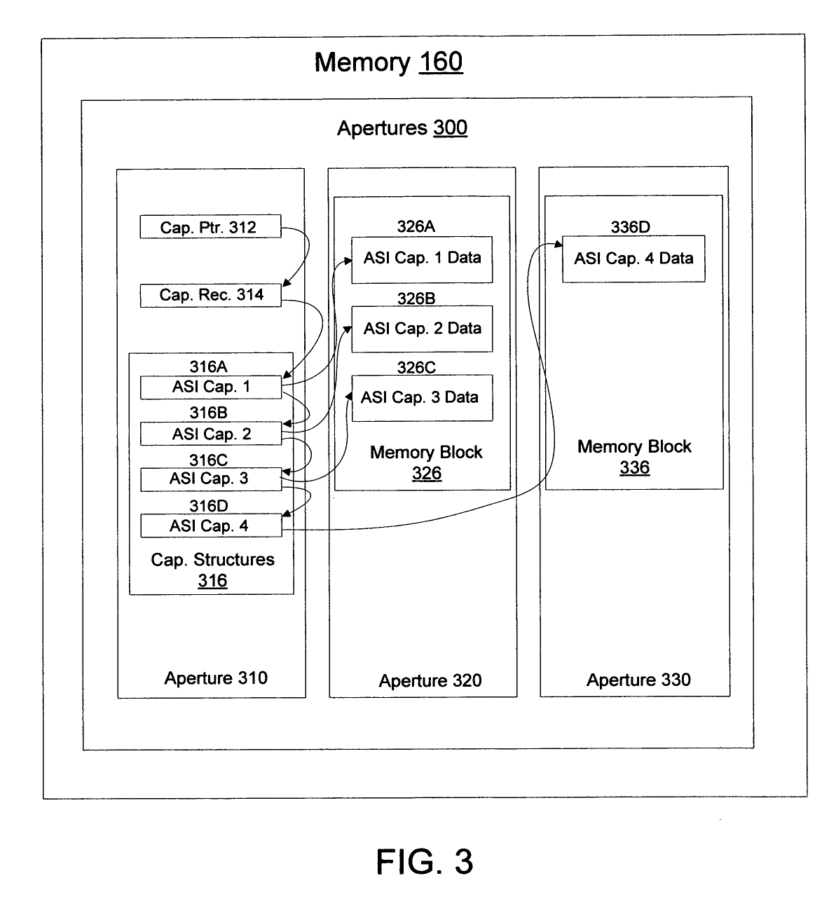

FIG. 3 is an illustration of apertures 300 in memory 160. As shown in FIG. 1, in one example, memory 160 is included in devices coupled to switch fabric 100. In one example, as depicted in FIG. 3, memory 160 includes apertures 300, and apertures 300 include apertures 310, 320 and 330. Each aperture, for example, is associated with sections or portions of physical memory that further include one or more memory locations. As described in more detail below, read or write requests may be addressed to a given aperture with an offset to indicate where in the aperture (e.g., a memory location) the read or write request is addressed. Although FIG. 3 portrays memory 160 with 3 apertures, this disclosure is not limited to a memory 160 that includes only 3 apertures. In other implementations, apertures 300 and/or memory 160 may include any number of apertures.

In one example, aperture 310 includes capability pointer 312, capability record 314 and capability structures 316. In one implementation, capability pointer 312 includes a pointer to indicate where in aperture 310 (e.g., via an offset) that capability record 314 is located. Capability record 314, for example, includes basic device or component information that may be used by a fabric manager (e.g., fabric manager 150) to uniquely identify a device coupled to a switch fabric. Capability record 314, in one example, also includes a pointer to a location in aperture 310 that includes capability structures 316. In one example, these capability structures are portrayed in FIG. 3 as capability structures 316A-D.

In one implementation, each capability structure of capability structures 316 includes information to identify a given capability that a device can support. For example, in an ASI compliant switch fabric 100, devices coupled to switch fabric 100 may indicate ASI capabilities in these capability structures. As portrayed in FIG. 3, in one example, these capabilities are denoted as ASI capabilities 1-4 for capability structures 316A-D, respectively. Each capability structure may also include a pointer or offset to indicate where the next capability structure (if one exists) is located. For example, the arrows connecting each capability structure of capability structures 316 illustrates in FIG. 3 this next capability indication. In this implementation, the last capability structure, 316D, does not have an arrow to the next capability structure because it is the last capability structure.

In one example, each capability structure of capability structures 316 may also include an indication of a memory location where information associated with the given capability is stored at a device. That information, for example, may be located at memory blocks 326 or 336 at aperture 320 and aperture 330, respectively or located at an other portion of memory 160. In one example, the arrows connecting capability structure 316A to capability data 326A at aperture 320 illustrates an indication of a memory location for information associated with a capability identified in capability structure 316A. The arrow connecting capability structure 316C to capability data 326C at aperture 320, for example, illustrates an indication of a memory location for information associated with a capability identified in capability structure 316C. Also an arrow connecting capability structure 316D to capability data 336D at aperture 330, for example, illustrates yet an other indication of a memory location for information associated with a capability identified in capability structure 316D.

In one example, capability data for a plurality of capabilities may be encompassed within a range of physical memory locations or blocks of memory. Thus as depicted in FIG. 3, capability data 326A, 326B and 326C are stored at physical memory locations that may include a block of memory locations 326. As described more below, a fabric manager, for example, can read that entire block to obtain information associated with more than one capability for a device to operate on a switch fabric.

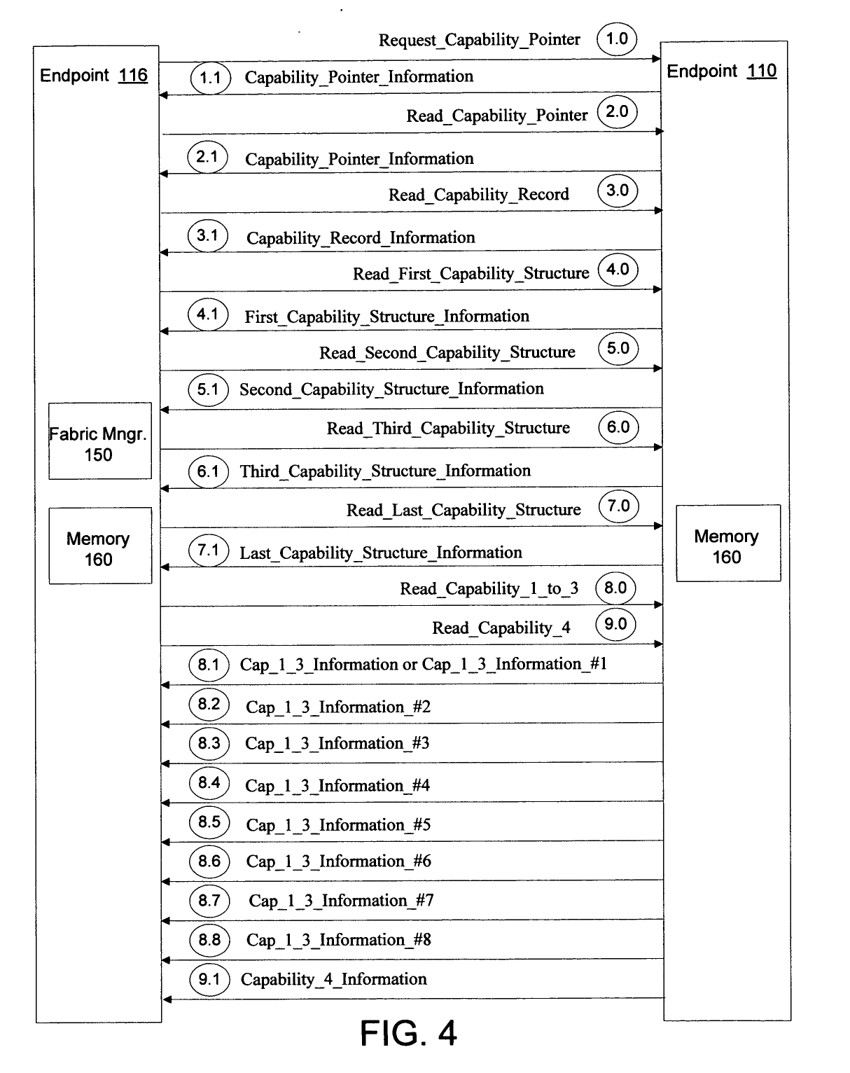

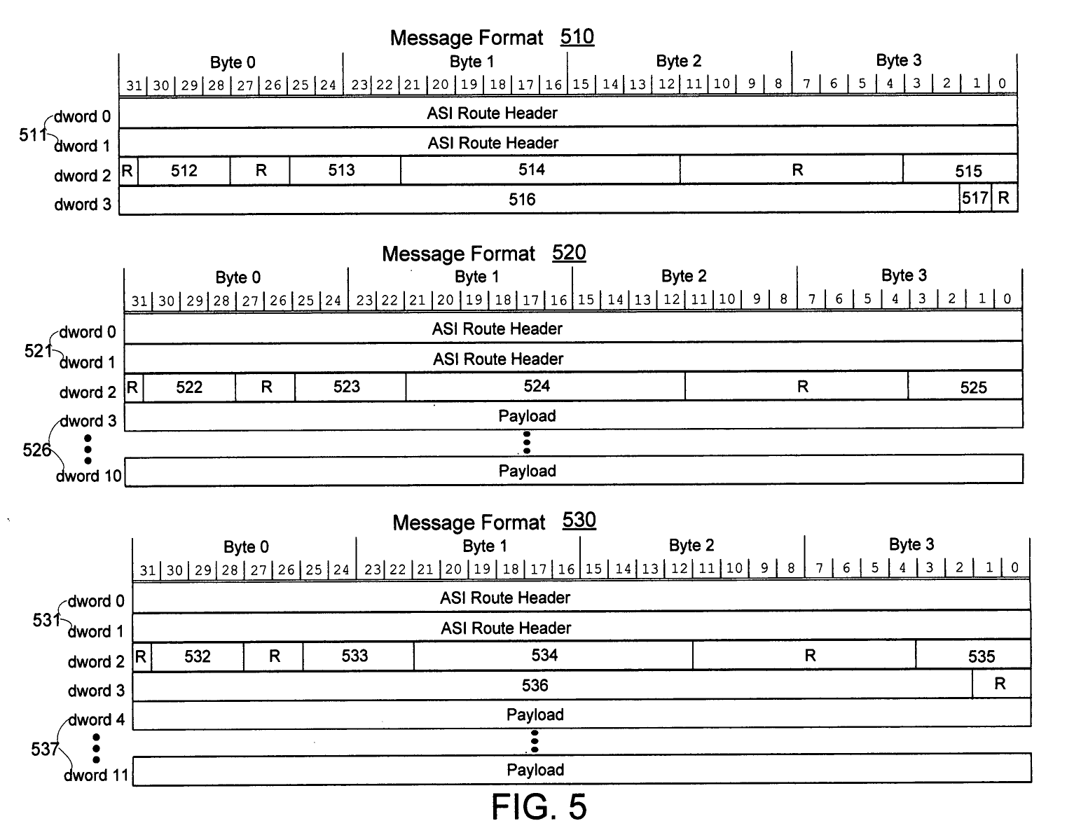

FIG. 4 is a diagram of an example scheme to discover endpoint 110 coupled to switch fabric 100. In one implementation, switch fabric 100 is an ASI-compliant switch fabric. In this implementation, as described above for FIG. 1, endpoint 116 hosts fabric manager 150 and endpoint 110 has been located via paths 141 and 142. In the example scheme depicted in FIG. 4, communication between fabric manager 150 is carried out, for example, over path 141. This communication, for example, includes the use of protocol interface (PI) 4 or “PI-4” read and write data packets. As described in the ASI specification, PI-4 read and write packets can be used by a fabric manager to collect capability information and configure a device. Example formats for the PI-4 read and write packets are described more below in relation to FIGS. 5A-C.

In one example, collected capability information can be used by fabric manager 150 to read one or more memory locations of memory 160 (e.g., at apertures 300) at endpoint 110. The memory locations, for example, are to include information or data associated with a plurality of capabilities for endpoint 110 to operate on switch fabric 100.

In the diagram depicted in FIG. 4, arrows show the direction of messages, labels identify the types of messages and the numbered circles show an example order of message generation by fabric manager 150 or endpoint 110. A message number X.0 indicates the initial message and a message numbered X.1 to X.n shows the subsequent messages generated as a result of that initial message.

In one example, at circle 1.0, fabric manager 150 generates and sends a message (e.g., a PI-4 read request) depicted as “Request_Capability_Pointer.” This message, for example, results in endpoint 110 generating and sending a response message (e.g., a PI-4 read completion) depicted as “Capability_Pointer_Location” at circle 1.1. For example, the “Capability_Pointer_Location” may include the location of capability pointer 312 in aperture 310 as described for FIG. 3.

At circle 2.0, for example, fabric 150 generates and sends a message depicted as “Read_Capability_Pointer.” In response, endpoint 110 generates and sends a “Capability_Pointer_Information” message. In one example, the capability pointer information in this message indicates the memory location of capability record 314 described above for FIG. 3.

At circle 3.0, for example, fabric manager 150 generates and sends a message depicted as “Read_Capability_Record.” In response, endpoint 110 generates and sends a “Capability_Record_Information” message. In one example, the capability record information in this message includes basic device or component information that may enable fabric manager 150 to uniquely identify endpoint 110. Capability record 314, in one example, also includes an indication of a location in aperture 310 that includes the first capability structure (e.g., capability structure 316A) of capability structures 316. In one example, fabric manager 150 retains (e.g., in a portion of memory 160 at endpoint 116) the basic device information for a capability table to be maintained for endpoint 110. This capability table, for example, is to include information associated with one or more capabilities for endpoint 110. As described below, based on the information included in each capability structure of capability structures 316, the memory location of this information is determined by fabric manager 150.

At circle 4.0, for example, fabric manager 150 generates and sends a “Read_First_Capability_Structure” message. This message for example, includes the memory location included in the “Capability_Record_Information” message depicted at circle 3.1. In response, endpoint 110 generates and sends a “First_Capability_Structure_Information” message. In one example, the first capability structure is capability structure 316A and it includes information that identifies a given capability for endpoint 111 (e.g., event reporting capabilities). Capability structure 316A, in this example, also includes a pointer or offset to indicate where capability structure 316B is located within aperture 310.

In one example, at circles 5.0, 6.0 and 7.0 and corresponding circles 5.1, 6.1 and 7.1, messages are exchanged between fabric manager 150 and endpoint 110 in a similar manner to obtain information from capability structures 316B-D. In this example, one difference is that since capability structure 316D is the last capability structure, it will include an indication that it is the last capability structure and this is denoted at circle 7.1 as a “Last_Capability_Structure_Information” message.

In one example, based on the exchange of messages at circles 1.0 to 7.0, fabric manager 150 has collected enough information to determine the memory locations at endpoint 110 where information associated with the capabilities described in capability structures 116A-116D are located. In one implementation, fabric manager 150 may determine that information for a plurality of capabilities are stored in one or more blocks of physical memory locations. As shown in FIG. 3, for example, memory locations 326 include data for ASI capabilities 1-3. In this implementation, fabric manager 150 generates a “Read_Capability_{—}1_to_{—}3” message as depicted at circle 8.0 where “1” represents a memory location for the first capability and “3” represents the memory location associated with the last capability in a block of memory locations. This message for example, causes endpoint 110 to respond with a “Cap_{—}1_{—}3_Information” message as depicted at circle 8.1. As described more below, (see FIG. 5A) these types of read request messages may indicate the size of the block of memory locations to read by indicating the number of double words or “dwords” to read starting at a given offset in an aperture.

In one implementation, fabric manager 110 has determined that endpoint 110 does not have the capability to support a block read request. In this implementation, fabric manager 150 generates a plurality of “Read_Cap_{—}1_to_{—}3” messages that cause endpoint 110 to respond with a corresponding number of “Capability_{—}1_to_{—}3_Information” messages as depicted as an alternative at circle 8.1 and at circles 8.2 to 8.9. Each “Read_Capability_{—}1_to_{—}3” message may have an identification number (see FIG. 5A) that allows fabric manager 150 to merge the responses (see FIG. 5B) and handle the merged responses as if a single block read response.

In one example, information for one or more capabilities may be located in disparate apertures and thus a single read request may not be able to read the different apertures. At circle 9.0, for example, a “Read_Capability_{—}4” is depicted, where “4” represents ASI capability 4 data. As depicted in FIG. 3, in one example, ASI capability 4 data is in memory location 336 of aperture 330 which is a different aperture than where the data for ASI capabilities 1-3 are stored. The “Read_Capability_{—}4” message for example, causes endpoint 110 to respond with a “Capability_{—}4_Information” message as depicted at circle 9.1.

In one example, whether sending one or a plurality of “Read_Capability_{—}1_to_{—}3” messages, or sending both a “Read_Capability_{—}1_{—}3” and a “Read_Capability_{—}4” message, the effect is that fabric manager 150 is enabled to read the one or more memory locations associated with a plurality of capabilities of endpoint 110 in a parallel manner. This is in contrast to the serial manner that the capability structures were read via the messages exchanged at circles 1.0 through 7.1. This parallel manner is depicted in FIG. 4, for example, as a message sent at circle 9.0 without waiting for a response for a message sent at circle 8.0. Thus, in one example, response messages depicted at circles 8.1-8.8 and 9.1 will follow the request messages depicted at circles 8.0 and 9.0.

FIGS. 5A-C are example message formats to discover and configure a device coupled to switch fabric 100. In one implementation these messages are formatted such that portions of each message are identified by a given bit, field, byte or dword as depicted in FIGS. 5A-C. Messages that utilize these message formats, for example, are used to exchange the messages as described in the diagram depicted in FIG. 4. Thus, in this implementation, switch fabric 100, fabric manager 150 and endpoint 110 operate in compliance with the ASI specification and each of the message formats includes an ASI route header. This ASI route header is depicted in fields 511, 521 and 531 for message formats 510, 520 and 530, respectively. As described in the ASI specification, the ASI route header includes information to route data packets between devices coupled to a switch fabric via a given path through the switch fabric.

In one example, the fields in message formats 510, 520 and 530 that include an “R” are reserved.

Message format 510 depicted in FIG. 5A, in one example, is used by a fabric manager to make read requests to devices coupled to a switch fabric. In one implementation, message format 510 is substantially similar to a PI-4 read request data packet format described in the ASI specification. Message format 510, for example, includes fields 511 to 517. Field 511, as mentioned above, includes an ASI route header.

Field 512, in one example, includes an indication that the data packet is a read request data packet. Field 513, in one example, includes an indication of the number of dwords (e.g., blocks of memory locations) that are to be read to complete the read request. Field 514, in one example, includes a transaction identification so that a fabric manager can identify a response message that is associated with the read request. In one example, a corresponding read completion message for a given read request will include the same transaction number in the read completion message. Also, for example, the transaction identification may be included in error messages (e.g., malformed data packet) so that the fabric manager can resend or regenerate a new read request.

Field 515, in one example, includes an aperture number to which the read request is being made. For example, as shown in FIG. 1, memory 160 includes apertures 310, 320 and 330. The information in field 515 in this example may indicate which of the apertures the read request is made to. Field 516, for example, is used to indicate the memory location offset in the aperture indicated in filed 515. This offset, for example, points to a memory location at the aperture where the read request is to begin.

Field 517, in one example, includes an indication of whether the read request is a block read request or a single dword read request.

Message format 520 depicted in FIG. 5B, for example, is used by devices coupled to a switch fabric to respond to read requests received from a fabric manager. In one implementation, message format 520 is substantially similar to a PI-4 read completion data packet format described in the ASI specification. Message format 520, for example, includes fields 521 to 526. Field 521, as mentioned above, includes an ASI route header.

Field 522, in one example, includes an indication that the data packet is a read completion data packet. Field 523, in one example, includes an indication of the number of dwords that are included in the payload of a data packet in format of message format 520. Field 524, in one example, includes a transaction identification so that a fabric manager can match the read completion message with that of the read request. As mentioned for field 514 in message format 510, in one example, a corresponding read completion message for a given read request will include the same transaction number in the read completion message. Field 525, in one example, includes an aperture number from which the read completion is read from.

Field 526, in one example, contains the payload for a read completion data packet in the format of message format 520. This payload, for example, may include 1 to 8 dwords and thus field 526 can include dword 3 for a 1 dword payload or dwords 3-10 for an 8 dword payload.

Message format 530 depicted in FIG. 5C, for example, is used by a fabric manager 150 to write information to a device coupled to switch fabric 100 to configure the device for operation on switch fabric 100. In one implementation, message format 530 is substantially similar to a PI-4 write data packet format described in the ASI specification. Message format 530, for example, includes fields 531 to 537. Field 531, as mentioned above, includes an ASI route header.

Field 532, in one example, includes an indication that the data packet is a write request data packet. Field 533, in one example, includes an indication of the number of dwords that are to be written to a memory location. Field 534, in one example, includes a transaction identification so that a fabric manager can identify possible error messages received and associated with the write request (e.g., malformed data packet or invalid write request) so that the fabric manager can resend or regenerate a new write request.

Field 535, in one example, includes an aperture number to which the write request is being made. Field 536, for example, is used to indicate the memory location offset in the aperture indicated in filed 535. This offset, for example, points to a memory location at the aperture where the write request is to begin.

Field 537, in one example, contains the payload for a write request data packet in the format of message format 530. This payload, for example, may include 1 to 8 dwords and thus field 537 can include dword 3 for a 1 dword payload or dwords 3-10 for an 8 dword payload. The payload included in a data packet in the format of message format 530, for example, may include capability information that a fabric manager uses to configure or initialize a device for operating on a switch fabric.

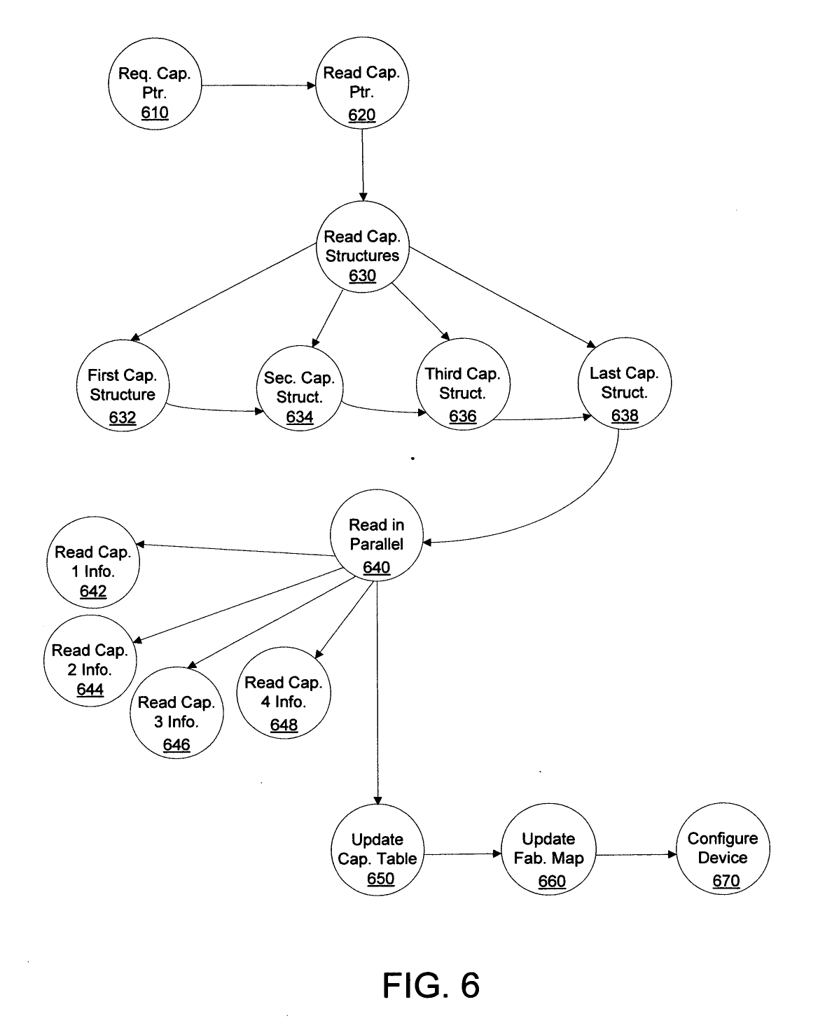

FIG. 6 is an example state diagram 600 that depicts states that fabric manager 150 may go through as it implements a scheme to discover devices coupled to switch fabric 100. In this implementation, switch fabric 100 is operated in compliance with the ASI specification and read request, read completion and write requests are exchanged via PI-4 data packets in the message formats described in FIGS. 5A-C.

At state 610, in one example, once a device is located, fabric manager 150 activates communicate feature 212 to generate a read request message in the format of message format 510. While in state 610, for example, fabric manager 150 is seeking to read the capability pointer 312 as depicted in aperture 310 in FIG. 3. This message is sent to the located device via a path through switch fabric 100.

At state 620, in one example, fabric manager 150 receives a read completion message in the format of message format 520 in response to the read request for capability pointer 312. Communicate feature 212, for example, extracts information from that response to determine the memory location for capability record 314 that is also in aperture 310. A read request message, for example, is then generated in the format of message format 510 by communicate feature 212 to read capability record 314 in aperture 310.

At state 630, in one example, fabric manager 150 receives a read completion message in the format of message format 520 in response to the read request for capability record 314. Fabric manager 150, for example, activates capability feature 214. Capability feature 214, for example, extracts basic device information from the response message. In one example this basic device information includes identification information for the device being discovered. In one example, capability feature 214 retains that information to start a capability table for the device. As mentioned above, in one example, this capability table may include information associated with a plurality of capabilities for the device to operate on switch fabric 100. This capability table, for example, is at least temporarily stored or maintained in a memory (e.g., a portion of memory 160) responsive to fabric manager 150.

Also while in state 630, in one example, fabric manager 150 seeks to read one or more capability structures of capability structures 316 in aperture 310. Communicate feature 212, for example, extracts information from the response received for reading capability record 314 to determine the memory location for the first capability structure of capability structures 316, e.g., capability structure 316A. A read request message, for example, is then generated in the format of message format 510 by communicate feature 212 to read capability structure 316A in region 2 of aperture 310.

At state 632, in one example, fabric manager 150 receives a read completion message in the format of message format 520 in response to the read request for capability structure 316A. Capability feature 214, for example, extracts any applicable capability information from the response message for reading capability structure 316A. This applicable capability information, for example, may include one or more memory locations where capability data is stored at the device. This capability data may be associated with a given capability, e.g., multicasting routing capabilities if the device is a switch or has switching capabilities. Capability feature 214 may collect this information in a parallel read table and at least temporarily store that parallel read table in a memory (e.g., a portion of memory 160). Communicate feature 212, for example, then extracts information from the response received for reading capability structure 316A to determine the memory location for the next capability structure of capability structures 316, e.g., capability structure 316B. A read request message, for example, is then generated in the format of message format 510 by communicate feature 212 to read capability structure 316B.

At states 634, 636 and 638, in one example, in order to read information at capability structures 326B-D the same extraction, collecting and generating processes are carried out by capability feature 214 and communicate feature 212. In one example, at state 638, communicate feature 212 determines that capability structure 316D is the last capability structure. Thus, in this example, no further read requests to read capability structures 316 are generated.

At state 640, in one example, capability feature 214 obtains the applicable memory locations for the capability data collected and temporarily stored in the parallel read table. As mentioned above, those memory locations were read from capability structures 316A-D. Communicate feature 212, in one example, based on the data collected in the parallel read table, determines capability data that can be read via one or more read requests and generates the one or more read request messages in the format of message format 510 in order to read the capability data in a parallel manner.

At states 642, 644, 646 and 648, in one example, communicate feature 212 generates and sends two read request messages in the format of message format 510. These two read request messages, for example, are to read the memory locations holding the capability data or information associated with the capabilities indicated in capability structures 316A-D. In one example, as shown in FIG. 3, capability information associated with the capabilities indicated in capability structures 316A (ASI capability 1), 316B (ASI capability 2) and 316C (ASI capability 3) are stored at aperture 320 in memory locations 326A-C. In this example, the data in these three locations amounts to an 8 dword block of memory. Also, in this example, the data for the capability indicated in capability structure 316D (ASI capability 4) is stored at aperture 330 in memory location 336D. Thus, a read request message for reading memory locations 326A-C and an other read request message for reading memory location 336D is generated and sent by communicate feature 212 to read the information associated with the 4 ASI capabilities in a parallel manner.

At state 650, in one example, in response to the two read request messages, fabric manager 150 receives two read completion messages in the format of message format 520. These read completion messages include the information associated with the 4 ASI capabilities indicated in capability structures 316A-D. Configuration feature 214, for example, extracts the capability information in the read completion messages and updates the capability table and at least temporarily stores or maintains the capability table in a memory responsive to fabric manager 150.

At state 660, in one example, fabric manager 150 activates configuration feature 216. Configuration feature 216, for example, enters the device in a switch fabric 100 map. The switch fabric 100 map, for example, is at least temporarily stored or maintained in a memory (e.g., a portion of memory 160) responsive to fabric manager 150. The switch fabric 100 map, for example, will serve as a mapping of the devices coupled to switch fabric 100 and discovered by fabric manager 150. This mapping, for example, may include the paths (primary and/or non-primary) via which communications can be routed though switch fabric 100 between fabric manager 150 and the discovered devices coupled to switch fabric 100. The mapping, for example, may also be associated with or includes a connection table that could be used by fabric manager 150 or other switch fabric 100 management services (e.g., a topology service) to calculate communication paths between devices coupled to switch fabric 100.

At state 670, in one example, configuration feature 216 may need to initialize the device for operation on switch fabric 100. Initialization, for example, includes assigning event reporting requirements for a device to monitor and report the results of the monitoring (e.g., data traffic congestion, link or port malfunctions, etc.). Configuration feature 216, for example, may use the information maintained in the device's capability table and the switch fabric 100 map to determine if the device has the capability to monitor and report on a given event and where the memory locations for configuring that capability are stored at the device. If it has the capability, configuration feature 216, for example, relays the monitoring and reporting requirements and the associated memory locations to communicate feature 212. Communicate feature 212, for example, generates and sends a write request message in the format of message format 530 that will write the monitoring and event reporting requirements to those memory locations.

As mentioned above for FIG. 1, in one example, a device provides privileged access to write to configuration memory if write requests are routed through a primary path. (e.g., path 141 between endpoint 110 and fabric manager 150). Communicate feature 212, for example, uses the switch fabric 100 map to determine the primary path and routes the write request via that path to configure the device.

In one implementation, endpoint 116 that hosts fabric manager 150 is a primary fabric manager for switch fabric 100. Although not shown in FIG. 1, switch fabric 100 may have other fabric manager 150s hosted by other endpoints coupled to switch fabric 100. These other fabric managers may serve as backups or secondary fabric managers for switch fabric 100 and thus provide a redundant management scheme should the primary fabric manager fail. In this implementation, the backup or secondary fabric managers may also go through at least states 610 to 660 to also discover and maintain device capability tables and a switch fabric 100 map. In one example, these fabric managers will complete their discovery after the primary fabric manager has completed its discovery. Should the primary fabric manager fail, for example, a secondary or backup fabric manager will then have the necessary information to configure devices and minimize the effects of losing the primary fabric manager.

Referring again to memory 160 in FIGS. 1-3. Memory 160 may include a wide variety of memory media including but not limited to memory registers, volatile memory, non-volatile memory, flash, programmable variables or states, random access memory (RAM), electronically erasable programmable read-only memory (EEPROM), flash, or other static or dynamic storage media. In one example, machine-readable instructions can be provided to memory 160 from a form of machine-accessible medium. A machine-accessible medium may represent any mechanism that provides (i.e., stores and/or transmits) information in a form readable by a machine (e.g., an ASIC, special function controller or processor, FPGA, endpoint device, switch device or other hardware device). For example, a machine-accessible medium may include a computer readable medium that includes: read-only memory (ROM); electrically EEPROM; RAM; magnetic disk storage media; optical storage media; flash memory devices. The machine accessible medium may also include a communication medium that includes: electrical, optical, acoustical or other form of propagated signals (e.g., carrier waves, infrared signals, digital signals) and the like.

In the previous descriptions, for the purpose of explanation, numerous specific details were set forth in order to provide an understanding of this disclosure. It will be apparent that the disclosure can be practiced without these specific details. In other instances, structures and devices were shown in block diagram form in order to avoid obscuring the disclosure.

References to the term “responsive to” are not limited to responsiveness to only a particular feature and/or structure. A feature may also be “responsive to” an other feature and/or structure and also be located within that feature and/or structure. Additionally, the term “responsive to” may also be synonymous with other terms such as “communicatively coupled to” or “operatively coupled to,” although the term is not limited in this regard.

What is claimed is:

1. In a switch fabric including a fabric manager, a method comprising:
implementing a scheme to discover one or more devices coupled to the switch fabric, the scheme to include:
locating a device coupled to the fabric manager via a path routed through the switch fabric;
collecting information via the path to determine one or more memory locations at the device that stores information associated with a plurality of capabilities for the device to operate on the switch fabric;
reading the one or more memory locations at the device based on the determination, the reading to occur such that the information associated with the plurality of capabilities is read in a parallel manner via the path;
maintaining a table for the device, the table to include the information associated with the plurality of capabilities that was read from the one or more memory locations, the table to be used to configure the device for operating on the switch fabric; and
entering the device in a fabric map for the switch fabric.

2. A method according to claim 1, wherein locating the device coupled to the fabric manager via the path routed through the switch fabric comprises determining that the path is a primary path that provides privileged access to the fabric manager to configure the device for operating on the switch fabric, based on a determination that the path is the primary path, the fabric manager to determine whether the device is associated with a unique identification and associates the device with a given unique identification if the device is not associated with a unique identification.

3. A method according to claim 2, further comprising:
initializing the device for operating on the switch fabric based on the information maintained in the table and based on the fabric map, the initializing to include the fabric manager writing information to at least a portion of the one or more memory locations at the device, the information written via the primary path.

4. A method according to claim 1, wherein the switch fabric comprises the switch fabric to operate in compliance with an Advanced Switching Interconnect specification to include Advanced Switching Interconnect Core Architecture Specification, Revision 1.1.

5. A method according to claim 4, wherein collecting information via the path to determine one or more memory locations at the device that stores information associated with the plurality of capabilities for the device comprises collecting information from a plurality of capability structures, each capability structure associated with a given capability, the plurality of capability structures to indicate the one or more memory locations at the device that stores information associated with the plurality of capabilities for the device, the information collected using protocol interface 4 (PI-4) read request and read completion data packets.

6. A method according to claim 5, wherein reading the one or more memory locations at the device based on the determination, comprises generating one or more PI-4 read request data packets to read the one or more memory locations, the one or more PI-4 read request data packets to cause the device to respond with one or more PI-4 read completion data packets, the one or more PI-4 read completion data packets to include the information associated with the plurality of capabilities for the device to operate on the switch fabric.

7. A method according to claim 5, wherein the plurality of capabilities for the device include at least one of: a unique identification capability, a communication protocol interface support capability, a given communication channel bandwidth capability, a multicasting route capability and a monitoring and event reporting capability.

8. A method according to claim 1, the path routed through the switch fabric that couples the device to the fabric manager comprises a non-primary path that does not provide privileged access to the fabric manager to configure the device for operating on the switch fabric, wherein the fabric manager is to:
collect information from the device to determine the device's unique identification;
consolidate the information maintained in the table that was read via the non-primary path with information received via a primary path that provides privileged access to the fabric manager to configure the device for operating on the switch fabric, the information received via the primary path maintained in an other table; and
remove the duplicate entry from the fabric map.

9. An apparatus comprising:
a device on a switch fabric to host a fabric manager, the device including logic for the fabric manager to implement a scheme to discover one or more other devices coupled to the switch fabric, the scheme to include the fabric manager to:
locate an other device coupled to the fabric manager via a path routed through the switch fabric;
collect information via the path to determine one or more memory locations at the other device that stores information associated with a plurality of capabilities for the other device to operate on the switch fabric;
read the one or more memory locations at the other device based on the determination, the fabric manager to read the information associated with the plurality of capabilities in a parallel manner via the path;
maintain a table for the other device, the table to include the information associated with the plurality of capabilities that was read from the one or more memory locations, the table to be used to configure the other device for operating on the switch fabric; and
enter the other device in a fabric map for the switch fabric.

10. An apparatus according to claim 9, wherein the switch fabric comprises the switch fabric to operate in compliance with an Advanced Switching Interconnect specification to include Advanced Switching Interconnect Core Architecture Specification, Revision 1.1.

11. An apparatus according to claim 10, wherein the fabric manager to collect information via the path to determine one or more memory locations at the other device that stores information associated with the plurality of capabilities for the other device comprises the fabric manager to collect information from a plurality of capability structures, each capability structure associated with a given capability, the plurality of capability structures to indicate the one or more memory locations at the other device that stores information associated with the plurality of capabilities for the other device, the information collected using protocol interface 4 (PI-4) read request and read completion data packets.

12. An apparatus according to claim 11, wherein the fabric manager to read the one or more memory locations at the other device based on the determination, comprises the fabric manager to generate one or more PI-4 read request data packets to read the one or more memory locations, the one or more PI-4 read request data packets to cause the other device to respond with one or more PI-4 read completion data packets, the one or more PI-4 read completion data packets to include the information associated with the plurality of capabilities for the other device to operate on the switch fabric.

13. An apparatus according to claim 10, wherein the plurality of capabilities for the other device include at least one of: a unique identification capability, a communication protocol interface support capability, a given communication channel bandwidth capability, a multicasting route capability and a monitoring and event reporting capability.

14. An apparatus according to claim 10, wherein the one or more memory locations at the other device comprises one or more apertures.

15. A switch fabric comprising:
a plurality of devices to include one or more endpoints and one or more switches; and
a device from among the plurality of devices, the device to host a fabric manager, the device to include logic for the fabric manager to implement a scheme to discover the plurality of devices, the scheme to include the fabric manager to:
locate a given device of the plurality of devices, the given device coupled to the fabric manager via a path routed through the switch fabric;
collect information via the path to determine one or more memory locations at the given device that stores information associated with a plurality of capabilities for the given device to operate on the switch fabric;
read the one or more memory locations at the given device based on the determination, the fabric manager to read the information associated with the plurality of capabilities in a parallel manner via the path;
maintain a table for the given device, the table to include the information associated with the plurality of capabilities that was read from the one or more memory locations, the table to be used to configure the given device for operating on the switch fabric; and
enter the given device in a fabric map for the switch fabric.

16. A switch fabric according to claim 15, wherein the switch fabric comprises the switch fabric to operate in compliance with an Advanced Switching Interconnect specification to include Advanced Switching Interconnect Core Architecture Specification, Revision 1.1.

17. A switch fabric according to claim 16, wherein the fabric manager to collect information via the path to determine one or more memory locations at the given device that stores information associated with the plurality of capabilities for the given device comprises the fabric manager to collect information from a plurality of capability structures, each capability structure associated with a given capability, the plurality of capability structures to indicate the one or more memory locations at the given device that stores information associated with the plurality of capabilities for the given device, the information collected using protocol interface 4 (PI-4) read request and read completion data packets.

18. A switch fabric according to claim 16, wherein the fabric manager to read the one or more memory locations at the given device based on the determination, comprises the fabric manager to generate one or more PI-4 read request data packets to read the one or more memory locations, the one or more PI-4 read request data packets to cause the given device to respond with one or more PI-4 read completion data packets, the one or more PI-4 read completion data packets to include the information associated with the plurality of capabilities for the given device to operate on the switch fabric.

19. A switch fabric according to claim 16, wherein the plurality of capabilities for the given device include at least one of: a unique identification capability, a communication protocol interface support capability, a given communication channel bandwidth capability, a multicasting route capability and a monitoring and event reporting capability.

20. A switch fabric according to claim 15, wherein the fabric manager comprises the fabric manager as a primary fabric manager and an other device from among the plurality of devices hosts a secondary fabric manager, the other device to include logic for the secondary fabric manager to implement the scheme implemented by the primary fabric manager to discover the plurality of devices, the secondary fabric manager to implement the scheme after the primary fabric manager has implemented the scheme.

21. A machine-accessible medium comprising content, which, when executed by an endpoint on a switch fabric causes the endpoint to:
host a fabric manager, the fabric manager to implement a scheme to discover one or more devices coupled to the switch fabric, the scheme to include the fabric manager to:
locate a device coupled to the fabric manager via a path routed through the switch fabric;
collect information via the path to determine one or more memory locations at the device that stores information associated with a plurality of capabilities for the device to operate on the switch fabric;
read the one or more memory locations at the device based on the determination, the fabric manager to read the information associated with the plurality of capabilities in a parallel manner via the path;
maintain a table for the device, the table to include the information associated with the plurality of capabilities that was read from the one or more memory locations, the table to be used to configure the device for operating on the switch fabric; and
enter the device in a fabric map for the switch fabric.

22. A machine-accessible medium according to claim 21, wherein the switch fabric comprises the switch fabric to operate in compliance with an Advanced Switching Interconnect specification to include Advanced Switching Interconnect Core Architecture Specification, Revision 1.1.

23. A machine-accessible medium according to claim 22, wherein the fabric manager to collect information via the path to determine one or more memory locations at the device that stores information associated with the plurality of capabilities for the device comprises the fabric manager to collect information from a plurality of capability structures, each capability structure associated with a given capability, the plurality of capability structures to indicate the one or more memory locations at the device that stores information associated with the plurality of capabilities for the device, the information collected using protocol interface 4 (PI-4) read request and read completion data packets.

24. A machine-accessible medium according to claim 23, wherein the fabric manager to read the one or more memory locations at the device based on the determination, comprises the fabric manager to generate one or more PI-4 read request data packets to read the one or more memory locations, the one or more PI-4 read request data packets to cause the device to respond with one or more PI-4 read completion data packets, the one or more PI-4 read completion data packets to include the information associated with the plurality of capabilities for the device to operate on the switch fabric.
